(19) United States
(12) Patent Application Publication
(10) Pub. No.: US 2026/0251781 A1
(43) Pub. Date: Aug. 27, 2026

(54) System And Method Of Stockpile Monitoring Using Synthetic Aperture Radar Imagery

(71) Applicant: Kayrros, Paris (FR)

(72) Inventors: Marie De Masson D'autume, Paris (FR); Charles Hessel, Paris (FR); Franco Marchesoni-Acland, Cachan (FR); Carlo De Franchis, Paris (FR); Gabriele Facciolo, Cachan (FR); Jean-Michel Morel, Paris (FR)

(73) Assignee: Kayrros, Paris (FR)

(21) Appl. No.: 18/992,427

(22) PCT Filed: Jul. 8, 2022
(86) PCT No.: PCT/IB2022/000510

§ 371 Date: Jan. 8, 2025

(51) Int. Cl. G01S 13/90; G06T 7/11; G06T 7/13; G06T 7/62; G06T 17/00

(52) U.S. Cl. CPC G01S 13/9021; G06T 7/11; G06T 7/13; G06T 7/62; G06T 17/00; G06T 2200/04; G06T 2207/10044; G06T 2207/30108; G06T 2207/30232

(57) ABSTRACT

The invention relates to a computer-implemented method of stockpile monitoring, comprising the steps of: obtaining an image of a ground surface area acquired by a remote sensing synthetic aperture radar; segmenting (SEG-HEAP) individual heaps in the obtained image; performing shape-from-shading reconstruction (SfS) of the segmented individual heaps, thereby determining a 3D model of each segmented individual heap.

### TECHNICAL FIELD

The field of the invention is that of material stockpile monitoring by remote sensing synthetic aperture radar (SAR) imagery, typically using SAR satellite images.

### DESCRIPTION OF RELATED ART

The storage and management of stockpiles of materials is a fundamental process in large scale activities such as civil engineering, mining and extraction and in the management of waste landfill sites. The ability to follow in real time the evolution of stocks is more and more important today. For instance, following the evolution of coal stocks over two years in European ports allowed to monitor the switch from coal to gas as countries seek to reduce their carbon footprint to combat climate change. On a more mundane level, knowing the evolution of coal stocks on a day-to-day basis makes it possible to anticipate the evolution of prices.

Continuous monitoring of stockpile volumes of goods is typically conducted manually using topographic surveying techniques. However, such methods have limitations regarding safety and access to the sites. Current trends to estimate these volumes use remote sensing tools such as airborne lidar scanners, stereo-photogrammetry from planes and Unmanned Aerial Vehicles (UAVs), and even photogrammetry from satellite imagery.

All these techniques are more precise, faster, safer and cheaper than the manual surveying measurements undertaken until a few years ago. The sheer number of commercial actors proposing UAV-based solutions proves the popularity of these methods. However, they fall short when the goal is to survey a large number of stocking areas around the world with a high frequency. Satellite images have the advantage over UAV-based imagery that they require no supervision, have a high revisit time and worldwide coverage. They also allow surveillance in areas of difficult access.

A SAR mounted on a satellite is an active sensor that first transmits microwave signals and then receives back the signals that are reflected from the surface of the Earth. Taking into account the motion of the radar antenna, the received signals are then processed to produce an image. One advantage of SAR images over optical images is that they do not require sunlight and are almost not affected by meteorological phenomena, e.g., clouds.

### BRIEF DESCRIPTION OF THE INVENTION

The invention aims at providing a solution for stockpiles monitoring that would make use of SAR images. In this respect, the invention provides a computer-implemented method of stockpile monitoring, comprising the steps of:
obtaining an image of a ground surface area acquired by a remote sensing synthetic aperture radar;
segmenting individual heaps in the obtained image;
performing shape-from-shading reconstruction of the segmented individual heaps, thereby determining a 3D model of each segmented individual heap.

Certain preferred, but non-limiting aspects of this method are as follows:
it further comprises the steps of segmenting and masking out individual cranes in the obtained image before segmenting the individual heaps therein;
segmenting an individual crane comprises intensity thresholding within a bounding box drawn around the individual crane;
masking out the individual cranes is preceded by a step of area filtering the segmented individual cranes to remove one or more connected components that have an area smaller than a predetermined threshold;
it further comprises delineating a region of interest within the obtained image and masking out in the obtained image parts of the ground surface area that are outside the region of interest;
it further comprises rotating the obtained image to have rails horizontal therein;
it further comprises segmenting and masking out the rails in the obtained image;
segmenting an individual heap in the obtained image comprises segmenting two unconnected components of the individual heap and merging the two unconnected components with an intermediate area therebetween;
the intermediate area comprises rows of pixels between a first one of the two unconnected components and the other one of the two unconnected component, the rows of pixels being aligned along a stockpile formation direction;
performing shape-from-shading reconstruction of the segmented individual heaps comprises, for each segmented individual heap, assigning an edge of the segmented individual heap at a ground level;
performing shape-from-shading reconstruction of the segmented individual heaps comprises determining heights in a ground range-azimuth plane of slope α with respect to the ground surface area and projecting the determined heights onto the ground surface area;
it further comprises determining a volume of each segmented individual heap based on its 3D model.

### BRIEF DESCRIPTION OF THE DRAWINGS

Other aspects, aims, advantages and features of the invention will better appear upon reading the following detailed description of preferred embodiments thereof, provided as a non-limiting example, and done in reference to the appended drawings, in which:

FIG. 1 is an example SAR image of a ground surface area;

FIG. 2 is an image illustrating pre-processing steps applied to the SAR image of FIG. 1;

FIG. 3 illustrates the segmenting of two unconnected components of an individual heap;

FIG. 4 illustrates the merging of the two unconnected components of FIG. 4;

FIG. 5 shows a shape-from-shading 3D reconstruction performed without previous segmentation of the individual heaps;

FIG. 6 shows a shape-from-shading 3D reconstruction performed with previous segmentation of the individual heaps;

FIG. 7 compare volume estimations performed with or without segmentation of the individual heaps.

FIG. 8 shows steps of a method according to a possible embodiment of the invention.

### DETAILED DESCRIPTION OF THE INVENTION

The invention relates to a computer-implemented method of stockpile monitoring, for instance for dry bulk commodities stockpiles such as sand, grain, gravel or ore (coal, copper or iron for instance) stockpiles.

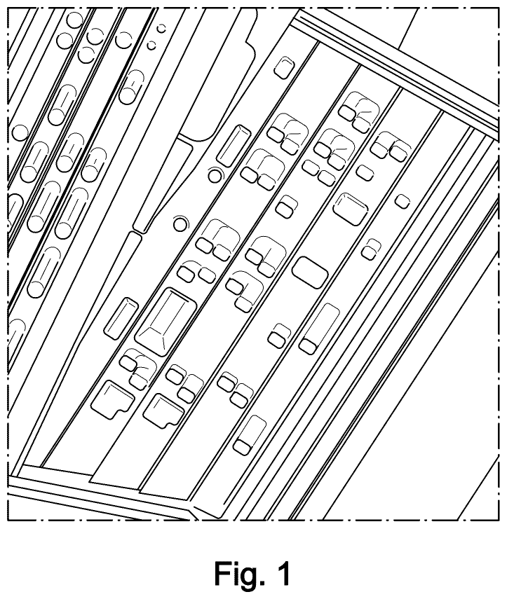

The method comprises a step of obtaining an image of a ground surface area acquired by a remote sensing synthetic aperture SAR radar, for instance a SAR radar onboard an Earth observation satellite. In this respect, FIG. 1 shows an example SAR image of a ground surface area of around 1.4*1.4 km² acquired by a satellite of the Capella constellation in the X-band (9.4-9.9 GHZ).

The method further comprises a step of segmenting individual heaps in the obtained image. As discussed, hereafter, this heap segmentation step may be performed after one or more pre-processing steps of the obtained image. These one or more pre-processing steps can be implemented once for each imaged ground surface area, in order to extract some site information which is useful to ignore parts of the image that are irrelevant for the use case thereby facilitating further processing.

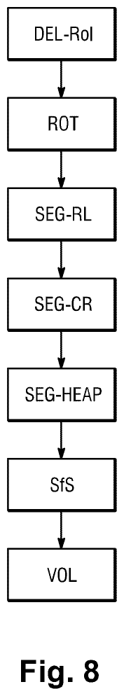

With reference to FIG. 8, a first pre-processing step DEL-Rol may comprise delineating a region of interest (i.e., a storage site) within the obtained image and masking out in the obtained image parts of the ground surface area that are outside the region of interest. The determination of the region of interest, which is the same from image to image of the monitored ground surface area, amounts to a negligible annotation time. For instance, the region of interest may be delineated by a polygon.

Other pre-processing steps may be implemented for regions of interest which have cranes on rails moving over the stockpiles to add and remove material thereto.

For instance, still with reference to FIG. 8, a second pre-processing step ROT may be implemented which comprises rotating the obtained image to have the rails horizontal therein. This rotation is conducted because the stockpile formation follows the natural direction of the rails, a diagonal in FIG. 1. The rotation angle can be easily obtained by selecting two points in a rail line.

A third pre-processing step SEG-RL may also be implemented which comprises segmenting and masking out rails in the obtained image. The rails may be masked out using bounding boxes.

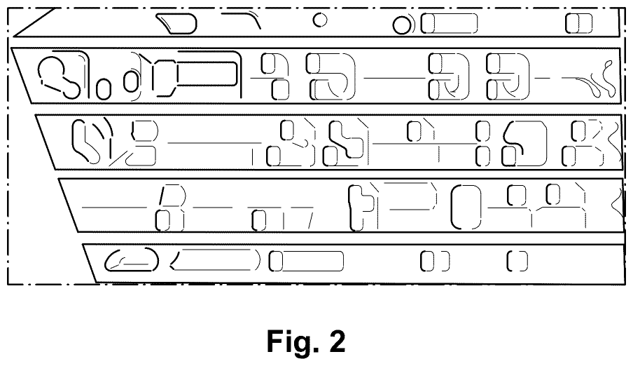

The output of these pre-processing steps is shown in FIG. 2. More specifically, in FIG. 2 a mask has been applied to retain only the region of interest and to remove therein the rails. In addition, a rotation has been applied to make horizontal the stockpile formations which we previously separated by the rails.

A fourth pre-processing step SEG-CR may also be implemented which comprises segmenting and masking out individual cranes in the obtained image.

First, the image may be smoothed using a Gaussian filter. This filter may be applied several times which equates to filtering with a wider Gaussian kernel (convolving n times a Gaussian with itself increases the resulting standard deviation by a Vn factor). This allows to remove details and control how fine-grained the segmentation should be.

Cranes produce distinctive bright reflections in the SAR image. However, segmenting them with a global threshold is not possible because both the cranes and the edges of the heaps present high intensity values. This is why local intensity thresholding is implemented. To do this, a bounding box is drawn around an individual crane and an intensity threshold is selected to be applied inside the bounding box.

Once the individual cranes are segmented, a step of area filtering the segmented individual cranes may be implemented to remove one or more connected components that have an area smaller than a predetermined threshold. This area filtering allows the removal of little connected components, while retaining big connected components such as the cranes.

As stated before, individual heaps segmentation SEG-HEAP is performed after these pre-processing steps. This segmentation may comprise intensity thresholding, here a global thresholding. Smoothing the image may therefore be advantageously performed, for instance by applying a non-local-means denoiser so as to preserve image edges. In addition, in order to be capable of detecting both dark and bright regions of the slopes of heaps with a single threshold, an absolute difference may be computed at each pixel between the pixel value in the obtained image and a background colour (characterizing a flat surface). The background colour may be calculated as a mean over a predefined area, such as a user-defined area (drawing a polygon for instance). In a possible embodiment, area filtering is performed after the segmentation to retain only sufficiently large components.

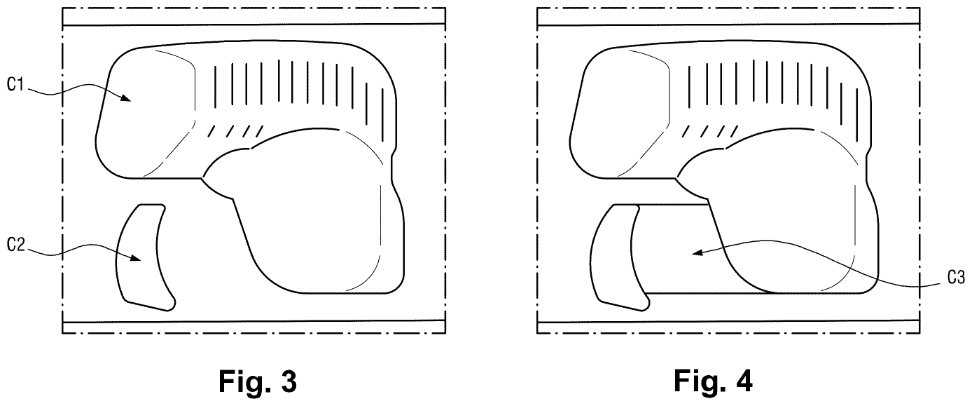

As shown on FIG. 3, segmenting an individual heap in the obtained image may result in segmenting two, or more, unconnected components C1, C2 of the individual heap. Indeed, sometimes the top of a heap has an intensity similar to the background and it is therefore hard to differentiate it from the background without further contextual information. As a result, after segmentation, some components corresponding to the same heap might be separated.

To deal with such unconnected components, the method may comprise as shown on FIG. 4 a step of merging the unconnected components C1, C2 with an intermediate area C3 therebetween. In a possible embodiment, the intermediate area C3 comprises rows of pixels between a first one C1 of the unconnected components and the other one C2 of the unconnected component, the rows of pixels being aligned along a stockpile formation direction. When rotation ROT of the SAR image has been previously applied to have the rails horizontal therein, the rows of pixels of the intermediate area C3 are horizontal.

In a possible embodiment, the merging process may involve user interaction. For instance, a user can draw a line between unconnected components C1, C2 to connect them. After each connection, a filling takes place (for instance a horizontal filling) and allows to easily segment all pixels of the intermediate area C3 between the two segmented components C1, C2.

While an interactive segmentation has been described so far in which a user may be involved in delineating the region of interest, in drawing bounding boxes around rails and cranes and in connecting heap components, the invention is not limited to such an implementation for segmenting heaps in a SAR image. Other image segmentation processes may be used, such as those relying on deep-learning methods that are trained or fine-tuned over annotated databases or those relying on the use of a paint-brush tool by a user to delineate cranes and heaps for instance.

After the individual heaps are segmented in the SAR image, the method according to the invention comprises a step (referred to as SfS on FIG. 8) of performing shape-from-shading reconstruction of the segmented individual heaps, thereby determining a 3D model of each segmented individual heap.

Shape-from-shading estimates the three-dimensional shape of a surface from one image of this surface. It is modelled by an image irradiance equation I(x, y)=R(n(x, y)), where I(x, y) is the gray level measured at pixel (x, y) and R is the reflectance function, giving the value of the light re-emitted by the surface z=u(x, y) as a function of its 3D normal n(x, y).

Most shape-from-shading methods assume the surface as Lambertian with a constant and known albedo and a unique far enough light source, so that the incident direction may be taken as constant, and a viewer standing far enough, so that the direction to the viewer is roughly constant in the scene. Under these hypotheses, the reflectance function is R(x, y)=A d·n, where the vector d=(α, β, γ) is the incident light direction and A is a constant modelling several proportionality factors, among which the albedo of the surface and the light source intensity.

In a classical optical shape-from-shading, the relief z=u(x, y) is seen from nadir, lit by the sun in direction (α, β, γ) with Lambertian albedo A and ambient light B. The observed image is thus

$$I ( x , y ) = A \frac{- α {u}_{x} - β {u}_{y} + γ}{\sqrt{1 + {u}_{x}^{2} + {u}_{y}^{2}}} + B .$$

When the sun is directly behind the camera (α,β,γ)=(0,0,1), this becomes

$$I ( x , y ) = \frac{A γ}{\sqrt{1 + {u}_{x}^{2} + {u}_{y}^{2}}} + B$$

which is an eikonal equation

$$‖ ∇ u ‖ = \sqrt{{( \frac{A γ}{I - B} )}^{2} - 1} .$$

In the context of the invention, the purpose is to find the relief h(x, y) of a segmented heap from the intensity of the SAR image I(x, y). The following two hypotheses are made to simplify the analysis.
Visibility (V): The antenna elevation is strictly larger than the maximum slope of the terrain. Thus, the whole surface is visible and there are no occlusions.
Lambertianity (L): The surface is uniformly covered by multi-directional point reflectors. The intensity of a radar pixel is proportional to the number of such reflectors covered by that pixel.

In practice, hypothesis (V) is often false, and hypothesis (L) is probably a good approximation. In addition, hypothesis (L) merits a clarification. The reflectors are uniformly distributed on the surface of the terrain. This means that, when parametrized by ground coordinates (x, y), this distribution is not uniform, but depends on the slope of the terrain at that point (the surface element).

On a y=constant plane, we consider two coordinate systems. The first one is the (x, z) plane in which the slice of relief z=h(x) is naturally described. The second system (t, s) is slanted by an angle α with respect to (x, y), where α denotes the elevation angle of the radar antenna above the horizon in the azimuth direction (1,0):

$$( \begin{matrix}cos α & sin α \\ - sin α & cos α\end{matrix} ) ( \begin{matrix}x \\ z\end{matrix} ) = ( \begin{matrix}t \\ s\end{matrix} )$$

Here, the t axis points to the antenna. Thus, the coordinates in the t axis are proportional to the distance to the antenna, and thus to the time. The slice of terrain in this axis is described by a function s=f(t).

Considering a surface element at position (x, h(x)), by change of coordinates, it is detected at position

$$\{ \begin{matrix}t = x cos α + h ( x ) sin α \\ s = - x sin α + h ( x ) cos α\end{matrix}$$

in the (t, s) coordinate system. This value of t is proportional to the column index in the SAR image.

The intensity of a projected surface element is the reflector density ρ weighted by the area element in (t, y, s) coordinates, thus

$$J ( t ) = ρ \sqrt{1 + {‖ ∇ f ‖}^{2}}$$

or, more explicitly

$$J ( t , y ) = ρ \sqrt{1 + {( \frac{\partial f}{\partial t} )}^{2} + {( \frac{\partial f}{\partial y} )}^{2}} . \qquad ( equation 1 )$$

Equation 1 is very similar to the optical shape-from-shading equation given above, but with inverse albedo. If the direction of the s axis is interpreted as the position of a “virtual camera” and also of the “virtual sun”, equation 1 is the shape-from-shading equation in the reverse: the minimum intensity happens for the surface elements whose normal points to the virtual sun, and the maximum intensity when the normal is perpendicular to the direction of the virtual sun.

By writing equation 1 as an Eikonal equation

$$‖ ∇ f ‖ = \sqrt{{( \frac{J}{ρ} )}^{2} - 1} ,$$

it can be seen that solving the SAR shape-from-shading is equivalent to solving the “sun-behind” optical shape-from-shading with the image J=c₁/(I−c₂) for certain constants c₁, c₂ to be determined from the image conditions. Notice that this is an inverse contrast change between J and I.

In other words, the SAR shape-from-shading can be determined by applying optical shape—from shading to the image J=c₁/(I−c₂), with the “sun” position and the camera position along the s axis at an angle α+π/2, where α is the elevation of the satellite. Stated differently, solving the SAR shape-from-shading is equivalent to solving the “sun-behind” optical shape-from-shading with an input proportional to the inverse of the observed image intensity, to which a constant has been subtracted.

The heights are therefore determined in the ground range-azimuth plane (t, s) of slope α with respect to the ground surface area. In this system of coordinates, the vector d is d=(1,0,0). A projection is thereafter performed to project the determined heights onto the ground surface area, thereby obtaining the function h.

When performing shape-from-shading, the invention models the ground as a slope whose angle depends on the incidence angle of the satellite. In other words, the invention handles the SAR shape-from-shading problem by considering the SAR image as an optical image seen from nadir, with sunlight coming from the horizon and bare ground having a slope of a (the elevation of the SAR satellite) rather than being horizontal. This slope is used to encode Dirichlet boundary conditions. In particular, for each segmented individual heap, an edge of the heap can be assigned at a ground level.

In addition, to deal with occluding objects like the cranes, homogeneous Neumann conditions may be enforced and the parts of the heaps that are hidden by the cranes may be interpolated with the heat equation, i.e., a smooth interpolator obtained by applying the Laplace equation with Dirichlet boundary condition on the boundary of the occluded region.

With reference to FIG. 8, the method may further comprise a step of determining a volume VOL of each segmented individual heap based on its 3D model. Such volume determination of an individual heap may be achieved by computing the integral of the elevation function given by the 3D model over the segmented heap domain, which in practice amounts to computing the sum of the voxels of the discrete 3D model.

The above-described method can be repeated over time with later acquired SAR images of the same ground surface area to allow time tracking the heaps, and in particular volume tracking.

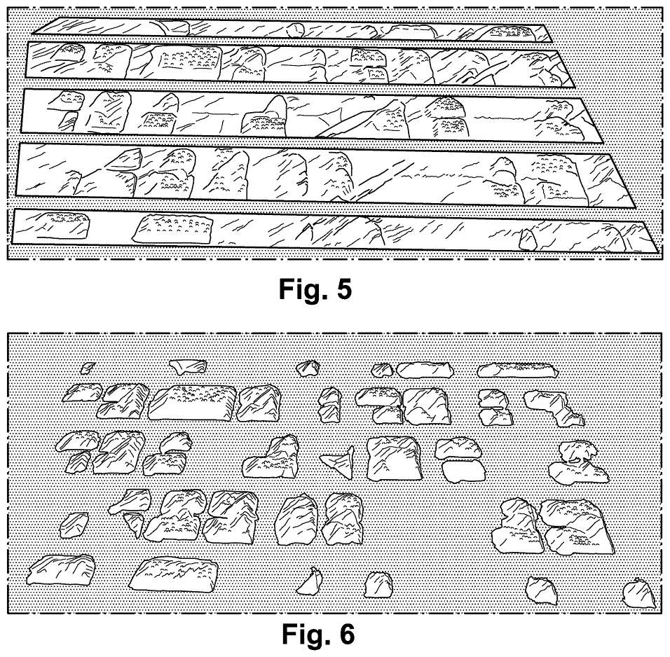

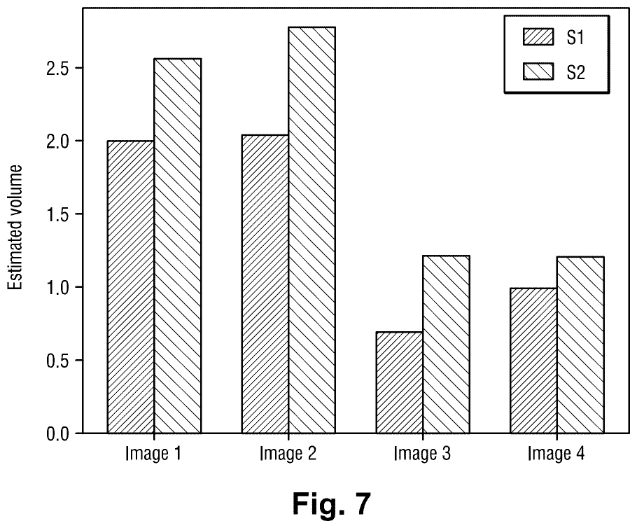

FIG. 5 shows a shape-from-shading 3D reconstruction of a ground surface area performed without previous segmentation of the individual heaps, while FIG. 6 shows a shape-from-shading 3D reconstruction performed in accordance with the invention with previous segmentation of the individual heaps. FIG. 7 compares volume estimations performed with (S2) or without (S1) segmentation of the individual heaps as total estimated volume per image.

The main advantage of the invention is that any incorrect estimation of the ground level is avoided, which is forced to be zero. The influence of this is quite drastic: for the image of FIG. 6, the volume estimated is 2.0, while the volume assigned to the ground for the image of FIG. 5 is −1.4, introducing a negative bias of 70%. When computing the bias introduced by the height estimation of the ground on other images, a similar behaviour was found. The minimum absolute bias introduced is 60% while the maximum is 100%. The average bias is −74.6%.

A non-negligible difference between the volume estimate with and without heaps segmentation is also observed as shown in FIG. 8. The phenomenon observed in FIG. 8 is explained by the effect of ground height estimation. As observed, the ground height estimation introduces a negative bias as the average ground height is negative. Thus, the heaps start from under zero height.

The invention is not limited to the above-described method but also extends to a computer program product comprising instructions which, when the program is executed by a computer, cause the computer to carry out this method as well as to a system for stockpile monitoring in synthetic aperture radar remote sensing images, comprising a processor configured to perform this method.

1. A computer-implemented method of stockpile monitoring, comprising the steps of:
obtaining an image of a ground surface area acquired by a remote sensing synthetic aperture radar;
segmenting individual heaps in the obtained image;
for each segmented individual heap, determining a 3D model of the segmented individual heap by performing shape-from-shading reconstruction of the segmented individual heap.

2. The computer-implemented method of claim 1, further comprising, before segmenting the individual heaps in the obtained image, the successive steps of segmenting and masking out individual cranes in the obtained image.

3. The computer-implemented method of claim 2, wherein segmenting an individual crane comprises intensity thresholding within a bounding box drawn around the individual crane.

4. The computer-implemented method of claim 2, wherein masking out the individual cranes is preceded by a step of area filtering the segmented individual cranes to remove one or more connected components that have an area smaller than a predetermined threshold.

5. The computer-implemented method of claim 1, further comprising delineating a region of interest within the obtained image and masking out in the obtained image parts of the ground surface area that are outside the region of interest.

6. The computer-implemented method of claim 1, further comprising rotating the obtained image to have rails horizontal therein.

7. The computer-implemented method of claim 6, further comprising segmenting and masking out the rails in the obtained image.

8. The computer-implemented method of claim 1, wherein segmenting an individual heap in the obtained image comprises segmenting two unconnected components of the individual heap and merging the two unconnected components with an intermediate area therebetween.

9. The computer-implemented method of claim 8, wherein the intermediate area comprises rows of pixels between a first one of the two unconnected components and the other one of the two unconnected component, the rows of pixels being aligned along a stockpile formation direction.

10. The computer-implemented method of claim 1, wherein performing shape-from-shading reconstruction of a segmented individual heap comprises assigning an edge of the segmented individual heap at a ground level.

11. The computer-implemented method of claim 1, wherein performing shape-from-shading reconstruction of a segmented individual heaps comprises determining heights in a ground range-azimuth plane of slope α with respect to the ground surface area and projecting the determined heights onto the ground surface area.

12. The computer-implemented method of claim 1, further comprising determining a volume of each segmented individual heap based on its 3D model.

13. A non-transitory computer-readable medium storing instructions which, when executed by a computer, cause the computer to carry out the method of claim 1.

14. A system for stockpile monitoring in synthetic aperture radar remote sensing images, comprising a processor configured to perform the method of claim 1.
